(19) United States
(12) Patent Application Publication
(10) Pub. No.: US 2026/0293845 A1
(43) Pub. Date: Oct. 1, 2026

(54) SCENTED SLEEVE FOR ANIMAL WATER BOWL

(71) Applicant: Logical Brands, Inc., Nashville, TN (US)

(72) Inventor: Lendy Beatty, Franklin, TN (US)

(21) Appl. No.: 19/090,110

(22) Filed: Mar. 25, 2025

(51) Int. Cl. A01K 7/00

(52) U.S. Cl. CPC A01K 7/00

(57) ABSTRACT

Non-toxic, replace elastomeric sleeves for water bowls for domestic pets are shown and described. The sleeves have a food flavor scent composition incorporated into the matrix of the elastomer which causes the sleeves to emit a scent that is detectable by domestic pets. The scent increases the engagement of the domestic pet with the water bowl and thereby increases the domestic pets water consumption. The sleeves are removable such that when the emitted scent becomes undesirably weak, the sleeve can be replaced and re-used with the same bowl. In addition, the availability of different sleeves with scents corresponding to different food flavors allows pet owners to determine which scents are most attractive to their pets and select a sleeve that is more likely to maximize the pet's engagement with its water bowl.

### FIELD

The present disclosure relates to removeable sleeves for animal water bowls, and more particularly, sleeves with an incorporated liquid natural food flavor scent composition that emits a scent corresponding to the food flavor.

### BACKGROUND

Proper hydration is vital to the health of animals, including domestic pets, such as cats and dogs. Water is an essential nutrient, but perhaps the least discussed with respect to dietary requirements. Water performs numerous important functions in an animal's body. Water carries important nutrients into and out of the cells of the body and aids in digestion and the absorption of nutrients. Water also regulates body temperature, lubricates joints, improves cognitive function, and cushions the brain and spinal cord. Every important bodily function requires water.

Like people, when pets do not get enough water, they don't function well. They feel groggy, lightheaded, and uncoordinated. Excessive loss of water, beyond what the body has taken in, is referred to as dehydration. When dehydrated, a pet's body draws water out of the cells, resulting in muscle dysfunction and electrolyte imbalance. Organ failure and death can follow if dehydration is not treated immediately.

Pet dehydration can happen easily. Pets lose water by normal reasons, like going to the bathroom, panting, and even breathing. They replenish this water by eating and drinking. Thus, dehydration can occur if your pet is not eating and drinking enough. Loss of appetite can be a sign of dehydration, so a vicious cycle can occur. Pets who exercise heavily or are exposed to hot, humid weather can become dehydrated easily. Heat stress, heat stroke, and dehydration often go hand in hand.

Studies have shown that increased water intake is beneficial for pets in a number of ways, including by diluting urine and reducing the likelihood of crystal formation and the ensuing creation or urinary tract stones, improving hot weather tolerance, improving digestion and nutrient absorption, lubricating joints, and promoting proper kidney function. Thus, a need for a way of promoting increased water intake by domestic pets has arisen.

### BRIEF DESCRIPTION OF THE DRAWINGS

The disclosure will now be described, by way of example, with reference to the accompanying drawings, in which:

FIG. 1 is front elevational view a sleeved animal water bowl comprising a removable sleeve that has an incorporated flavor scent composition showing the sleeve in an installed condition on the water bowl;

FIG. 2 is a top perspective view of the sleeve of FIG. 1 in an uninstalled condition;

FIG. 3 is a front elevational view of the sleeve of FIG. 1 in an uninstalled condition;

FIG. 4 is a bottom plan view of the sleeved animal water bowl of FIG. 1 with the sleeve installed on the animal water bowl;

FIG. 5 is a front elevational view of the bowl of FIG. 1 without a sleeve installed; and

FIG. 6 is a flow chart illustrating a method of making the removable sleeve of FIG. 1.

### DETAILED DESCRIPTION

The present disclosure relates to sleeves for animal water bowls, in particular water bowls used by domestic pets. The sleeves removably enclose at least a portion of the water bowl and include a flavor scent composition that is distributed throughout the polymeric material from which the sleeves are constructed. The flavor scent composition is emitted from the sleeve to generate an attractive scent that entices the animal to the water bowl, thereby encouraging the consumption of increased amounts of water and improved hydration. In preferred examples, the flavor scent compositions have a scent corresponding to a particular type of food item. In the same or other examples, the entirety of the sleeve and its ingredients are non-toxic to animals. In the same or other examples, there are no openings through the sleeve or decorative features that reduce the scent retaining capacity of the sleeve.

The sleeves can be used with standard water bowls, and no modifications to the bowl are required. In particular, the bowl does not need to have any special compartments for holding flavor scent compositions and does not need to be replaced to change the flavor scent. Also, different sleeves with different flavor scent compositions may be used, allowing pet owners to experiment with sleeves having different incorporated flavor scent compositions to see which one has the greatest ability to attract a particular animal and increase the animal's water consumption. Thus, the bowl itself does not require any special compartments or sections for holding a scent compound and can be re-used with different sleeves.

The sleeves are preferably elastic so that they can be stretched and snugly fit over the animal's water bowl and readily removed, including to wash the bowl and when the flavor scent composition has been depleted to an undesirable level. In certain examples, the sleeves are sufficiently elastic such that they can be expanded to an expanded configuration and snugly installed on a bowl while still having sufficient structural integrity to retain a cylindrical sleeve shape when detached from the bowl and placed on a flat surface. The sleeves also have a tensile strength and tear strength sufficient to endure the repeated removal of the sleeve from the bowl and reinstallation of the sleeve on the bowl.

The flavor scent composition is preferably incorporated throughout the elastomeric sleeve and may be incorporated throughout the elastomeric sleeve's polymeric matrix (i.e., throughout the continuous polymer phase of the elastic sleeve). In certain preferred examples, the flavor scent is a food flavor scent, i.e., a composition that gives off the scent of a food product and which, if ingested, may also taste like that food product. Preferred food flavor scents include beef, chicken, peanut butter, cheddar cheese, sweet potato pie, and bacon flavor scents. The flavor scent composition is preferably a liquid comprising one or more flavor compounds which collectively define the scent corresponding to the flavor.

The flavor scent is preferably incorporated throughout the elastomeric material used to form the sleeve as part of a process of forming the sleeve. In contrast to scents that are applied on a surface of the sleeve, incorporation of the flavor scent throughout the elastomeric material allows for the slow and gradual release of the flavor scent from the sleeve. In certain preferred examples, the flavor scent is provided as an emulsified combination of the flavor scent composition and a solvent during the formation of the sleeve. In one preferred implementation, the emulsified combination of the flavor scent composition and the solvent is mixed with the elastomer during a cross-linking or vulcanization process to create sheets of cured, flavor scent-infused, vulcanized elastomer. Strips of that scent-infused, vulcanized elastomer are then fed to an injection molding machine to mold the rubber into the sleeve. As explained below, the molding process is carried out at process conditions that may volatilize or otherwise degrade the flavor scent composition in the absence of emulsification.

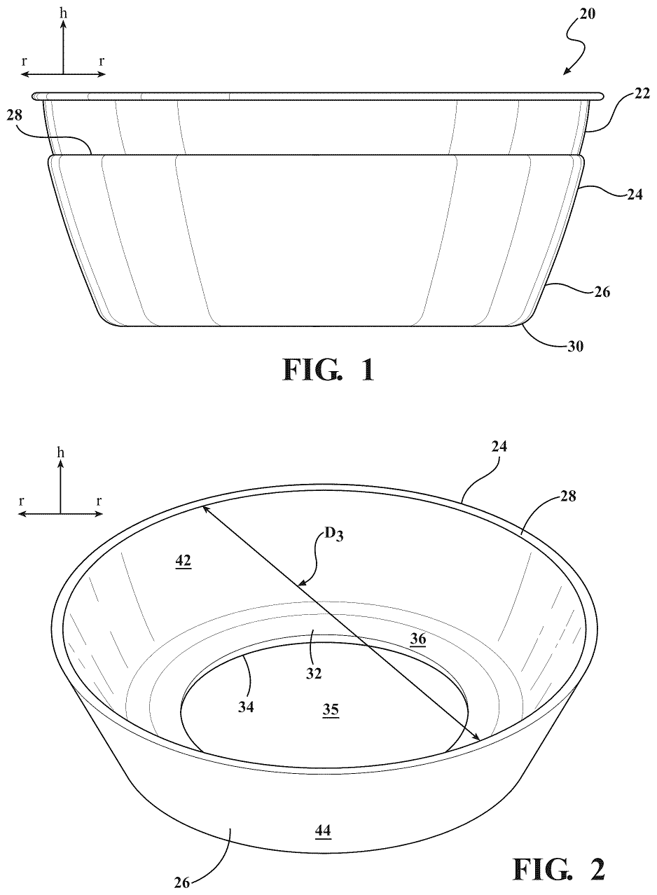

Referring to FIG. 1, an animal feeding bowl assembly 20 is depicted. The animal feeding bowl assembly 20 is a sleeved animal feeding bowl comprising a bowl 22 and an elastic sleeve 24. The elastic sleeve 24 is removably attached to and snugly fits around the bowl 22 and extends along at least a portion of the height of the bowl 22 along the height axis h.

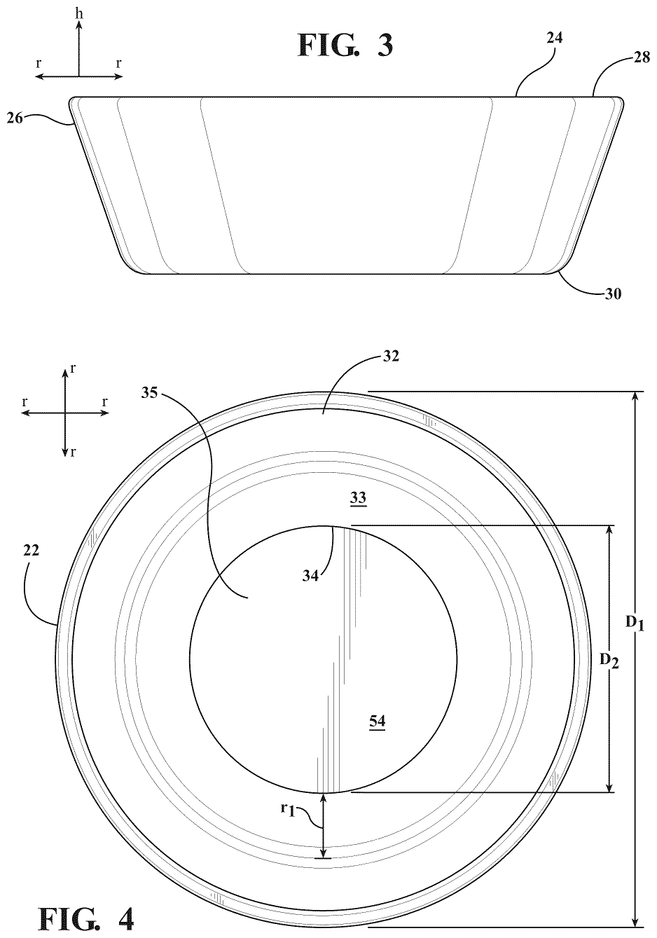

Referring to FIGS. 2-3, elastic sleeve 24 is shown removed from bowl 22 in a detached condition. As shown in the figure, when in the detached condition, the elastic sleeve 24 comprises a cylindrical side wall 26 that includes a top edge 28. Top edge 28 defines an opening that is perpendicular to the height axis h at the top of sleeve 24. Cylindrical side wall 26 includes an inner surface 42 and an outer surface 44 that are spaced apart by the radial axis r thickness of the elastic sleeve 24.

The cylindrical side wall 26 is attached to a flange 32 that projects away from the inner surface 42 of cylindrical side wall 26 inwardly along radial axis r. A transition region 30 that is generally curved outwardly along the radial axis r connects the cylindrical side wall 26 to the flange 32, as best seen in FIGS. 1 and 3.

Elastic sleeve 24 includes a flavor scent composition and is preferably formed from an elastomer. In certain examples, elastic sleeve 24 is formed from a vulcanized elastomer that is formed from a base polymer and a vulcanizing agent. In preferred examples, the flavor scent is provided as an emulsion that is combined with base polymer during crosslinking, preferably, to yield a homogeneous, flavor scent-infused, unmolded elastomeric material before molding. The flavor scent composition is preferably incorporated within the material used to form elastic sleeve 24 before it is molded into the shape of sleeve 24, and preferably without spraying or coating the flavor scent composition on the external surface of sleeve 24.

As used herein, the term “emulsion” refers to a liquid system in which one liquid (the “dispersed phase”) is dispersed in another liquid (the “continuous phase”). Thus, the emulsion comprises a liquid flavor scent composition that itself comprises at least one flavor compound with a scent corresponding to the flavor. The emulsion also comprises at least one liquid solvent and is formulated so that an liquid-liquid emulsion of the flavor scent composition and the solvent is created. In some cases, the nature of the flavor composition and the one or more solvents is such that an emulsion will naturally form without the addition of a separate emulsifier. In other cases, an emulsifier may be added to facilitate the creation of an emulsion between the one flavor scent composition and the one or more solvents.

Without wishing to be bound by any theory, it is believed that by incorporating the flavor scent compositions as an emulsion into the unmolded base polymer, the polymer/flavor scent system can be formulated to have a flash point (i.e., a temperature at which the flavor scent composition begins to flash off during molding) that is sufficiently high to withstand polymer processing temperatures (e.g., molding temperatures) that would otherwise degrade the flavor composition in the absence of emulsification. In certain examples, the flavor scent emulsion is combined with a rubber base polymer and a vulcanizing agent during a vulcanization step, possibly with one or more accelerating agents, and formed into sheets that serve as the feed to an injection molding machine.

Referring to FIG. 4, additional details regarding preferred aspects of the geometry of sleeve 24 will ow be described. Flange 32 includes an upward facing surface 36 (FIG. 2) and a downward facing surface 33 (FIG. 4), each of which is perpendicular to the height axis h. The downward facing surface 33 defines a bottom surface of elastic sleeve 24 that rests on a surface such as a floor or countertop. As FIGS. 2 and 3 indicate, in the detached state the elastic sleeve 24 has sufficient structural integrity to stand upright without any external support (other than the table, countertop, etc. on which the downward facing surface 33 rests). Thus, elastic sleeve 24 maintains the cylindrical sidewall 26 in a generally vertical orientation relative to the earth and in a generally perpendicular orientation relative to the flange 32 without any external support other than the surface on which the downward facing surface 33 of flanged 32 rests. In the example of FIGS. 2 and 3, the cylindrical sidewall 26 is not perfectly perpendicular to the surface on which the sleeve 24 rests or with respect to flange 32. Instead, the cylindrical side wall 26 flares outwardly along the radial axis r while moving along the height axis h in a direction away from the flange 32.

Referring to FIG. 4, in certain examples, the open area at the top of the sleeve 24 (i.e., the area of the opening perpendicular to height axis h which is defined by the diameter of the top edge 28 of the sleeve 24) is related to the area of the flange 32. The open area at the top of the sleeve (Aₜₒₚ) can be determined from the diameter of the top opening (D₃) as follows:

$${A}_{top} = ( π / 4 ) {( {D}_{3} )}^{2} \qquad ( 1 )$$

As shown in FIG. 4, the area of the bottom surface 33 of the flange 32 perpendicular to the height axis h can be determined as follows:

$${A}_{flange} = ( π / 4 ) [ {( {D}_{1} )}^{2} - {( {D}_{2} )}^{2} ] \qquad ( 2 )$$

Thus, the ratio of the flange area to the open top area can be determined as follows:

$${A}_{flange} / {A}_{top} = [ {( {D}_{1} )}^{2} - {( {D}_{2} )}^{2} ] / {( {D}_{3} )}^{2} \qquad ( 3 )$$

In equations (1)-(3), D₁ is the diameter of the bottom surface of the sleeve 24 defined by the radially outermost extent of flange bottom surface 33. D₂ is the diameter of the opening 35 defined by the radially inner edge 34 of the flange 32 (FIG. 2). The radial dimension of the flange r₁ (FIG. 4) may be determined as follows:

$${r}_{1} = ( {D}_{1} - {D}_{2} ) / 2 \qquad ( 4 )$$

In certain preferred examples of the bowl assembly 20, the ratio of A_{flange} to Aₜₒₚ in accordance with equation (3) is less than about 0.5, more preferably, less than about 0.45, and still more preferably less than about 0.35. At the same time, the ratio of A_{flange} to Aₜₒₚ is preferably at least about 0.1, more preferably at least about 0.2, and still more preferably at least about 0.25. In addition, the sleeve top opening diameter D₃ and area are preferably greater than the sleeve bottom opening 35 diameter D₂ and its area, respectively.

As shown in FIG. 4, the portion of the bottom surface 54 of the bowl 22 that lies within the opening 35 (FIG. 2) is visible when the bowl assembly 20 is viewed in a bottom plan view. As compared to other designs in which the sleeve 24 has a continuous bottom without opening 35, the design of FIGS. 1-4 provides an anti-skid feature while reducing the amount of material required to form elastic sleeve 24. In addition, the design allows engravings or other markings on the bottom surface 54 of bowl 22 to be seen.

Sleeve 24 is elastic, i.e., it can be deformed by a deforming force and returns to its original shape upon release of the deforming force. In certain preferred examples, the unmolded, scent-infused vulcanized material used to form sleeve 24 is elastomeric and has a percent elongation (at rupture) under a tensile load of at least about 400 percent, preferably at least about 500 percent, more preferably at least about 550 percent, and still more preferably at least about 600 percent. Percentage elongation may be determined using procedures known to those skilled in the art such as ASTM D-412. In certain examples, sleeve 24 is formed entirely from an elastic material. In other examples, sleeve 24 is formed entirely from an elastomeric material. In additional examples, sleeve 24 is formed from a single elastomeric material created by cross linking a precursor composition that includes one or more polymeric precursors that react to form the single elastomeric material.

In the same or other examples, the unmolded, scent-infused, vulcanized material used to form sleeve 24 has a density of at least about 0.8 g/cm³, preferably at least about 0.95 g/cm³, and more preferably at least about 1.15 g/cm³. At the same time, the density of sleeve 24 is no more than about 1.5 g/cm³, preferably no more than about 1.3 g/cm³, and more preferably no more than about 1.2 g/cm³.

In the same or other examples, the unmolded, scent-infused, vulcanized material used to form sleeve 24 has a tearing strength of at least about 30 kg_{f}/cm², preferably at least about 40 kg_{f}/cm², and more preferably at least about 45 kg_{f}/cm². Tearing strength may be determined using procedures known to those skilled in the art such as ASTM D-624. At the same time or in other examples, sleeve 24 has a tensile strength that is preferably at least about 140 kg_{f}/cm², more preferably at least about 160 kg_{f}/cm², still more preferably at least about 170 kg_{f}/cm². Tensile strength may be determined using procedures known to those skilled in the art such as ASTM D-412.

In the same or other examples, the unmolded, scent-infused, vulcanized material used to form elastic sleeve 24 has a shore A hardness that is at least about 40, more preferably at least about 42, still more preferably at least about 45, and even more preferably at least about 48. At the same time, elastic sleeve 24 has a shore A hardness that is preferably no more than 60, more preferably no more than about 58, still more preferably no more than about 55, and still more preferably no more than about 52.

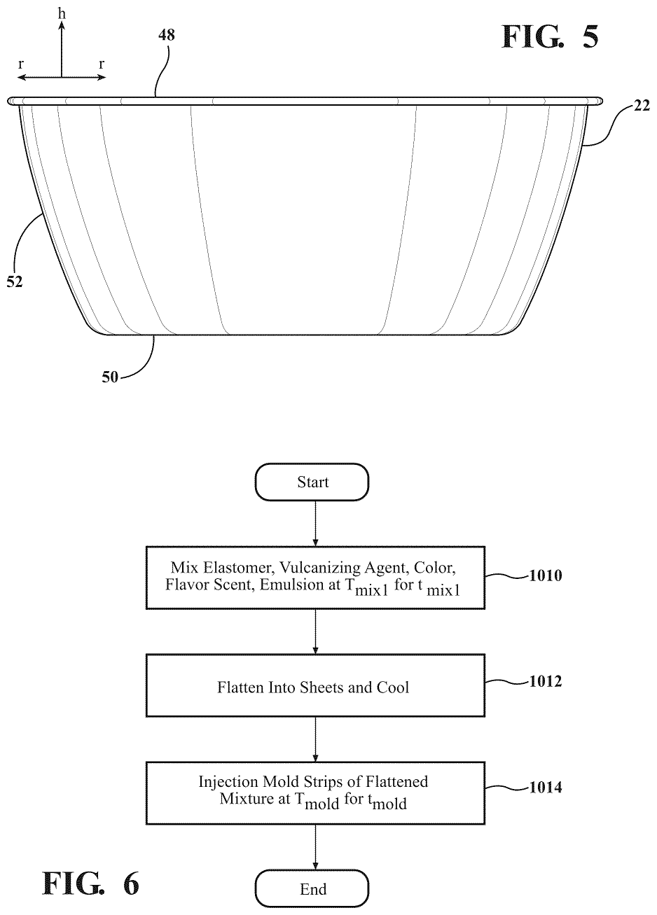

In the example of FIGS. 1-4, the elastic sleeve 24 is held in place on bowl 22 by the elastic restoring force of the sleeve 24 material. When elastic sleeve 24 is in the detached condition (i.e., not installed on bowl 22) of FIGS. 2-3, the sleeve 24 has a first, detached state diameter at the top sleeve edge 28. However, when the sleeve 24 is installed on bowl 22 as shown in FIGS. 1, the sleeve 24 has a second, attached state diameter at the top sleeve edge 28. The second, attached state diameter is greater than the detached state diameter. As a result, the elasticity of the sleeve 24 creates a restoring force directed along the radial axis r which causes the inner surface 42 of the cylindrical side wall 26 to exert a force against the outer surface of the bowl side wall 52 (FIG. 5). The exerted force will have a component that is perpendicular to the outer surface of the bowl side wall 52, thereby creating a frictional force that holds the sleeve 24 in place on the bowl 22. In general, when the sleeve 24 is installed on the bowl 22 as shown in FIG. 1, each cylindrical sidewall 26 location along the height axis h will have an attached state diameter that is greater than its corresponding detached state diameter. Thus, in certain preferred examples, the sleeve 24 snugly engages the outer surface of the bowl side wall 52 around substantially or all of the entirety of the side wall's circumference and along substantially or all of the entire height of sleeve 24 along the height axis h. As a result, the bowl assembly 20 requires no mechanical fasteners or connections to securely engage the sleeve 24 to the bowl 22, yet sleeve 24 remains removably attached to bowl 22.

As shown in FIG. 5, the bowl 22 comprising bowl assembly 20 is a standard, stainless steel bowl with a sidewall 52 that has a continuously smooth outer surface and a closed bottom 50. The bowl includes a top edge 48 (FIG. 5) on an outwardly projecting lip. The top edge 48 defines a circular opening perpendicular to height axis h. The bowl 22 does not include any designed-in features used to engage the sleeve 24. Instead, the elastic force exerted by the sleeve 24 against the bowl 22 is sufficient to hold the sleeve 24 securely in place. Correspondingly, the inner surface 42 of the sleeve cylindrical side wall 26 and the upward facing surface 36 of the sleeve flange 32 are smooth and do not include any designed-in surface features to secure the sleeve 24 to the bowl 22.

In certain preferred examples, bowl 22 is formed from stainless steel and is dishwasher safe. Unlike many ceramics, stainless steel is typically dishwasher safe. Thus, in certain preferred examples, the bowl assembly 20 of FIGS. 1-5 provides a flavor scent while still allowing the bowl 22 to be cleaned in a dishwasher by removing the sleeve 24. At the same time, the inner surface 42 of the sleeve side wall 26 and the upward facing surface 36 (FIG. 2) of the flange 32 are less likely to become dirty or fouled by water or food because of their close fitting engagement to the bowl 22. In addition, the sleeve 24 can be replaced as desired to provide a bowl assembly with different flavor scent using the same bowl 22.

In certain examples, the flavor scent emulsion is formulated such that the vulcanized base polymer/flavor scent composition system is a homogeneous system having a flash point that is close enough to (or in excess of) the processing temperatures used to form a finished sleeve 24 with a desirable amount of flavor scent emanating from it. In the processes of forming sleeve 24 described herein, the base polymer/flavor scent system is subjected to molding times and temperatures of at least about 135° C., preferably at least about 140° C., and more preferably at least about 145° C. and which is no greater than 165° C., preferably no greater than 160° C., and more preferably no greater than 155° C. for a molding period of from about 4 minutes to about 12 minutes, preferably from about 5 minutes to about 10 minutes, and more preferably from about 7 minutes to about 8 minutes.

In certain examples, the flavor scent emulsion comprises a flavor scent composition and a solvent. Exemplary flavor scent compositions suitable for sleeve 24 herein include food flavor scents such as beef, chicken, peanut butter, cheddar cheese, sweet potato pie, and bacon. However, other natural flavors may be used. The flavor scent composition comprises one or more compounds that collectively generate a scent corresponding to the flavor, and in some preferred examples, the flavor scent composition also has a taste corresponding to that scent, e.g., a beef flavor scent composition tastes and smells like beef.

In some cases, the flavor scent emulsion comprises a separate emulsifier in addition to the flavor scent composition and the solvent. In other cases, the solvent and flavor scent composition form an emulsion without the use of a separate emulsifier, and in other cases the flavor scent composition includes an emulsifier.

In certain examples, the flavor scent emulsions comprise, and preferably consist of, “natural flavors,” as defined in the April 2017 Revision of 21 C.F.R. 101.22(a)(3). In certain examples, the dispersed phase is the flavor scent composition, and the continuous phase is a solvent, such as one or more carboxylic acid triglyceride esters. In other examples (known as “reverse emulsions”), the dispersed phase is the solvent and the continuous phase is the flavor scent composition. In preferred examples, the flavor scent emulsions are “natural,” which as defined herein means that each ingredient thereof is a plant, animal, or mineral derivative that has not undergone chemical modification. As explained above, the terms “natural flavor” or “natural flavors” refer to the definitions provided in the April 2017 Revision of 21 C.F.R. 101.22(a)(3).

The solvent component of the flavor scent emulsions described herein is one or more natural, organic compounds. The solvents include carboxylic acid triglyceride esters, such as medium chain triglycerides (“MCT”) or triacetin, which are carboxylic acid triglyceride esters. Triacetin is a glycerol molecule that has been esterified with three acetic acid molecules. MCTs comprise a group of triglycerides having three medium chain length (about 6-12 carbon) fatty acid molecules esterified to a glycerol molecule. In one example, the continuous phase consists essentially of or consists of a mixture of decanoyl and octanyol glycerides (which are species of MCTs in which glycerol molecules have been esterified with one or two decanoic acid or octanoic acid molecules).

In certain cases, the flavor scent composition and the solvent form an emulsion when combined in selected concentrations without the need of a separate emulsifying agent. However, in other cases, a separate emulsifying agent is combined with the solvent and the flavor scent composition. Such separate emulsifying agents include mixed esters of glycerin, such as those in which one or more of the hydroxyl groups of glycerin has been esterified by diacetyl tartaric acid and by fatty acids to yield a diacetyl tartaric acid ester of mono and diglycerides, commonly known as “DATEM.” DATEM is a natural esterifying agent. Another suitable emulsifier is sunflower oil, which can also act as a solvent.

Sleeve 24 is formed by vulcanizing a base polymer to yield an elastomer with desired properties and then molding the elastomer into the shape of sleeve 24. Suitable base polymers for forming elastic sleeve 24 include synthetic rubbers, polyisoprene rubbers, and natural rubber (polyisoprene rubbers derived from natural sources). The natural rubber may be provided as a natural rubber latex. One suitable commercially available rubber is RSS-3 (“Ribbed Smoked Sheets, Grade 3”) supplied by Lien Anh Production Rubber Co., Ltd. of Vietnam. The rubber is preferably combined with a vulcanizing agent in a concentration C_{V1} sufficient to yield the desired physical properties, such as Shore A hardness, percent elongation, etc. In certain examples, when preparing sleeve 24, the vulcanizing agent is added in an amount of from about 0.5 to about 2.5 PHR (pounds of vulcanizing agent per hundred pounds of rubber), preferably from about 0.8 to about 2.2 PHR, and more preferably from about 1.5 to about 2.0 PHR. Preferred vulcanizing agents include sulfur compounds. One suitable commercially available vulcanizing agent is 4,4′-DTDM-80, an 80 percent (by weight) dispersion of 4, 4′-Dithiodimorpholine with 20 percent (by weight) polymer binder (EPDM/EVM) and a dispersing agent). 4, 4′-DTDM-80 is a free sulfur donor under normal curing conditions that leads to mono and di-sulfur cross-links with excellent heat aging properties. The recommended dosage of 4, 4′ DTDM 80 is 1.0 to 2.0 PHR.

In certain examples, accelerators and/or auxiliary accelerators may also be used to speed up the vulcanization process. If used, the accelerator is preferably added in an amount ranging from about 0.1 PHR to about 3.0 PHR, preferably from about 0.2 PHR to about 2.6 PHR, and more preferably from about 0.4 to about 2.0 PHR. One suitable commercial accelerator is n-tert-butyl-2-benzothiazole sulfonamide. Suitable auxiliary accelerators include tetramethylthiuram monosulfide, which if used is preferably present in an amount ranging from about 0.1 to about 0.6 PHR, preferably from about 0.13 PHR to about 0.55 PHR, and more preferably from about 0.15 to about 0.5 PHR.

In preferred examples, sleeve 24 (i.e., including both the base polymer and the flavor scent emulsion) is non-toxic. As used herein, the term “non-toxic”, as it pertains to sleeve 24 or a component thereof, means that no compound on the list of “Chemicals of High Concern for Children (CHCC)” in the State of Washington (as defined by the Revised Code of Washington, Chapter 70.240.040 and the Washington Administrative Code chapter 173-334) is present in an amount greater than the detection limit of 30 ppm by weight of the sleeve or component thereof, respectively. In preferred examples, the flavor scent emulsion consists exclusively of ingredients registered with FEMA GRAS (Flavor & Extract Manufacturers Association and Generally Regarded as Safe). In certain examples, the sleeve complies with Intertek Pet Toy Test Protocol ITS-08001-US, Version 11 and/or Intertek Toy Test Protocol ITS-16001-US, Version 23.0. In the same or other preferred examples, the sleeve complies with the Consumer Product Safety Improvement Act (CPSIA) and/or California Proposition 65.

In the same or other preferred examples, the ingredients in the flavor scent composition portion of the flavor emulsion are selected to be compliant with the Official Publication (OP) of the Association of American feed Control Officials (AAFCO).

In certain examples, the flavor scent emulsion is combined with the base polymer (e.g., synthetic or natural rubber) during a cross-linking step, and more preferably, a vulcanization step. The flavor scent emulsion is combined with the base polymer, vulcanizing agent(s), any accelerating agents, and color agents, in an amount by weight of the base polymer that ranges from about 0.5 percent to about five (5) percent, preferably from about 1.0 percent to about 4.0 percent, and still more preferably from about 1.5 percent to about 2.5 percent. The flavor scent emulsions described herein contain a flavor scent composition in an amount that depends on the particular flavor scent. However, in general the flavor scent emulsions described herein contain a flavor composition that is present in an amount by weight of the flavor scent emulsion that is at least about one (1) percent, more preferably, at least about two (2) percent, and still more preferably at least about 2.5 percent. In the same or other examples, the flavor scent composition is present in an amount by weight of the flavor scent emulsion that is no more than about 80 percent, preferably no more than about 75 percent, and still more preferably no more than about 70 percent.

When used as a solvent in the exemplary flavor emulsions herein, the MCTs comprise the continuous phase and may vary with the type of flavor being used. In general, and for the flavor scent compositions described herein, when MCTs are used as the solvent, they are provided in amounts of at least about 40 percent, preferably at least about 50 percent, and more preferably at least about 55 percent by weight of the flavor scent emulsion.

In certain examples herein, triacetin is used as the solvent and comprises the dispersed phase, with a bacon flavor scent composition comprising the continuous phase. In accordance with such examples, triacetin is present in an amount by weight of the flavor scent emulsion ranging from about 0.5 to about 10 percent, preferably from about 0.7 to about 8 percent, and more preferably from about 1 to about 5 percent. The relative concentrations of flavor scent composition and solvent are preferably selected to maximize the amount of flavor composition while at the same time preserving the emulsified nature of the combined liquids (i.e., while not “breaking” the emulsion) and achieving a high enough flash point to survive the polymer processes (e.g., molding) used to form the sleeves.

In certain examples, and in particular, in certain examples involving beef, bacon, cheddar cheese, and sweet potato pie flavor compositions herein, the flavor emulsion also preferably includes a separate emulsifying agent. Suitable emulsifying agents include mixed esters of glycerin, and more preferably mixed esters of glycerin in which one or more of the glycerin hydroxyl groups has been esterified by diacetyl tartaric acid and by fatty acids resulting in a diacetyl tartaric acid of mono and diglycerides. One suitable emulsifying agent is a plant-based (derived from plant sources) diacetyl tartaric acid of mono and diglycerides, commonly known as DATEM in the art. Sunflower oil is also a suitable emulsifier. Where the emulsifying agent is used, its preferred concentration may vary with the flavor particular flavor scent composition and/or its corresponding solvent.

In the case of a chicken flavor composition, the amount of flavor scent compound added during the mixing of sleeve 24 components by weight of the sleeve 24 ranges from about 0.01 to about 0.45, preferably from about 0.04 to about 0.324, and more preferably from about 0.075 to about 0.25 percent by weight of sleeve 24.

In the case of beef flavor composition, the amount of flavor scent composition added during the mixing of the sleeve 24 components by weight of the sleeve 24 ranges from about 0.005 to about 0.36 percent, preferably from about 0.02 to about 0.27 percent, and more preferably from about 0.045 to about 0.20 percent. In the case of sweet potato pie flavor composition, the amount of flavor scent compound added during the mixing of the sleeve 24 components by weight of the sleeve 24 ranges from about 0.025 to about 0.45, preferably from about 0.06 to 0.38, and more preferably from about 0.12 to about 0.33

In the case of bacon flavor, the amount of bacon flavor compound added during the mixing of the sleeve 24 components by weight of the sleeve 24 ranges from about 0.06 to about 0.78 percent, preferably from about 0.15 to about 0.65 percent, and more preferably from about 0.26 to about 0.55 percent. In the case of peanut butter, the amount of peanut butter flavor compound added during the mixing of the sleeve components by weight of the sleeve ranges from 0.10 percent to about 1.05 percent, preferably from about 0.22 percent to about 0.86 percent, and more preferably from about 0.36 percent to about 0.73 percent.

In the case of cheddar cheese flavor, the amount of the cheddar cheese flavor compound added during the mixing of the sleeve 24 components by weight of the sleeve components is from about 0.31 percent to about 2.0 percent, preferably from about 0.62 percent to about 1.8 percent, and more preferably from about 0.93 percent to about 1.7 percent.

In certain examples of a sleeve 24 with an incorporated flavor scent composition comprising a peanut butter flavor scent composition, the peanut butter flavor scent composition by weight of the flavor scent emulsion is preferably from about 20 percent to about 35 percent, preferably from about 22 percent to about 32 percent, and more preferably from about 25 percent to about 30 percent. In the same or other examples, the emulsion comprises a solvent that comprises medium chain triglycerides in an amount by weight of the emulsion ranging from about 60 percent to 80 percent, preferably form about 65 percent to about 77 percent, and more preferably from about 68 percent to about 76 percent. In the same or other examples, the MCT solvent and peanut butter flavor scent composition form an emulsion without the inclusion of a separate emulsifying agent.

In certain examples of a sleeve 24 with an incorporated flavor scent composition comprising a cheddar cheese flavor scent composition, the cheddar cheese flavor scent composition by weight of the flavor scent emulsion is from about 55 percent to about 75 percent, preferably from about 60 percent to about 70 percent, and more preferably from about 62 percent to about 67 percent. In the same or other examples, the flavor scent emulsion solvent preferably comprises medium chain triglycerides present in an amount by weight of the emulsion ranging from about 20 percent to about 45 percent, preferably from about 25 percent to about 40 percent, and more preferably from about 30 to about 35 percent. A DATEM emulsifier is preferably present in a non-zero amount by weight of the emulsion of not more than about five percent, preferably not more than about four percent, and more preferably not more than about two percent.

In certain examples of sleeve 24 with an incorporated flavor scent comprising a sweet potato pie flavor scent composition, the sweet potato pie flavor scent composition by weight of the sweet potato pie flavor scent emulsion is from about 5 percent to about 15 percent, preferably from about 6 percent to about 14 percent, and more preferably from about 8 percent to about 13 percent. In the same or other examples, the flavor scent emulsion solvent is preferably a combination of triacetin and medium chain triglycerides. The medium chain triglycerides are preferably present in an amount by weight of the emulsion ranging from about 65 percent to about 90 percent, preferably from about 70 percent to about 85 percent, and more preferably from about 75 percent to about 80 percent. Triacetin is present in an amount by weight of the emulsion ranging from about five percent to about fifteen percent, preferably from about six percent to about fourteen percent, and more preferably from about 7 to about 12 percent by weight of the emulsion. A DATEM emulsifier is preferably present in a non-zero amount by weight of the emulsion of not more than about five percent, preferably not more than about four percent, and more preferably not more than about two percent.

In certain examples of sleeve 24 with an incorporated beef flavor scent composition and an MCT solvent, the amount of the beef flavor scent composition by weight of the beef flavor scent emulsion is preferably from about one (1) percent to about 20 percent, preferably from about two (2) percent to about 10 percent, and more preferably from about three (3) percent to about eight (8) percent. At the same time, the amount of medium chain triglyceride solvent ranges from about 50 percent to about 75 percent, preferably from about 55 percent to about 70 percent, and more preferably from about 60 percent to about 65 percent. In the same or other examples, a sunflower oil is present in an amount by weight of the emulsion which ranges from about 20 percent to about 40 percent, preferably from about 25 percent to about 35 percent, and more preferably from about 28 percent to about 33 percent.

In certain examples of sleeve 24 with an incorporated chicken flavor scent composition and an MCT solvent, the amount of the chicken flavor scent composition by weight of the chicken flavor scent emulsion ranges from about 3 to about 20 percent, preferably from about 4 to about 15 percent, and more preferably from about 5 to about 10 percent. At the same time, the amount of medium chain triglyceride solvent ranges from about 80 to about 98 percent, preferably from about 85 percent to about 96 percent, and more preferably from about 89 percent to about 94 percent. In the same or other examples, no separate emulsifying agent is used.

In certain examples of sleeve 24 with an incorporated bacon flavor scent composition and an MCT solvent, the amount of the bacon flavor scent composition by weight of the bacon flavor scent emulsion ranges from about 12 percent to about 26 percent, preferably from about 15 percent to about 24 percent, and more preferably from about 17 percent to about 22 percent. At the same time, the amount of medium chain triglyceride solvent by weight of the bacon flavor scent emulsion ranges from about 55 percent to about 85 percent, preferably from about 60 percent to about 80 percent, and more preferably from about 67 percent to about 72 percent. In the same or other examples, a DATEM emulsifying agent is present in an amount by weight of the flavor scent emulsion which ranges from about 3 percent to about 16 percent, preferably from about 5 percent to about 13 percent, and more preferably from about 7 percent to about 12 percent.

In certain other examples of sleeve 24 with an incorporated bacon flavor scent composition and a triacetin solvent, the bacon flavor composition is provided as part of a reverse emulsion, i.e., with a solvent that forms the dispersed phase in a continuous phase of the bacon flavor composition. In accordance with one example, a triacetin solvent is provided in amounts by weight of the reverse emulsion ranging from about 0.5 to about 10 percent, preferably from about 0.7 to about 7 percent, and more preferably from about one to about 5 percent. In accordance with such examples, the bacon flavor composition is provided in an amount by weight of the reverse emulsion ranging from about 90 percent to about 99.8 percent, preferably from about 92 to about 99.6 percent, and more preferably from about 94 to about 99 percent.

A method of making sleeve 24 will now be described with reference to FIG. 6. In step 1010 a base polymer, preferably an elastomer such as a synthetic or natural rubber, is mixed with a vulcanizing agent of the type described previously, a flavor scent emulsion of the type described previously, a coloring agent, and possibly one or more accelerating agents. The vulcanizing agent is provided at a vulcanizing agent concentration Cᵥ₁ that is selected to achieve desired physical properties, such as shore A hardness, percent elongation, etc. The mixing step is carried out for a mixing time tₘᵢₓ₁ at a mixing temperature of Tₘᵢₓ₁. The mixing time tₘᵢₓ₁ ranges from about 4 minutes to about 12 minutes, preferably from about 5 minutes to about 10 minutes, and more preferably from about 7 minutes to about 8 minutes. The mixing temperature Tₘᵢₓ₂ ranges from about 135° C. to about 165° C., more preferably from about 140° C. to about 160° C., and more preferably from about 145° C. to about 155° C. In step 1012 the mixture of step 1010 is flattened using a roller assembly to create sheets of vulcanized rubber. The sheets are preferably cooled prior for at least about two hours, preferably at least about four hours, and more preferably, at least about eight hours prior to molding.

In step 1014 the sheets of vulcanized rubber are fed to an injection molding machine (preferably by cutting them to an appropriate size for introduction into the machine) comprising two mold halves that collectively define the shape of sleeve 24. The injection molding process is carried about at an injection molding temperature of from about 135° C. to about 165° C., preferably from about 140° C. to about 160° C., and more preferably from about 145° C. to about 155° C. for an injection molding period of from about 4 minutes to about 12 minutes, preferably from about 5 minutes to about 10 minutes, and more preferably from about 7 minutes to about 8 minutes.

Following the molding process, sleeve 24 preferably has a human-detectable concentration of the flavor scent composition that was incorporated in step 1013. It is believed that the emulsification of the flavor scent compounds is responsible for the survival of the flavor scent compound in sleeve 24 in human detectable concentrations.

### Example

This example demonstrates the effect of the scented sleeves described herein on canine water consumption, and more specifically, demonstrates that dogs who have a preference for sleeves with a particular flavor scent will tend to consume more water when the scented sleeve is used than if an unscented sleeve is used. Twenty owned domestic dogs are recruited, each of which is older than one year old, healthy, and up to date on its vaccinations. To account for bias of multi-animal households, all but six (6) of the dogs come from a household in which they are the only resident dogs. Six (6) are from multi-dog households with the proviso that there is no sharing of water bowls and that the experiment is carried out for pairs of dogs residing at the same household at the same time.

Elastic bowl sleeves like sleeve 24 are prepared using beef, chicken, peanut butter and non-scented sleeves. The elastic bowl sleeves are manufactured using an RSS-3 (“Ribbed Smoked Sheets, Grade 3”) supplied by Lien Anh Production Rubber Co., Ltd. of Vietnam. The elastic sleeves are prepared by vulcanizing the RSS-3 rubber by mixing the raw rubber with one or more vulcanizing agents and the flavor scent emulsion at a temperature ranging from about 145° C. to about 155° C. for a period of from about 430 seconds to about 470 seconds, flattening and cooling the vulcanized, scent-infused rubber into sheets, and then introducing strips of the sheets into an injection molding machine comprising two mold-halves that define the shape of the sleeve. The concentrations of the flavor scent emulsion, the vulcanizing agents, color agents, and acceleration agents are the same as are the process conditions of the mixing and flattening steps. However, the flavor scent emulsion is omitted in the case of the non-scented sleeves. The amount of flavor scent emulsion added in step 1010 is about 2.5 percent by weight of the RSS-3 rubber.

The flavor scent emulsion for beef comprises a beef flavor scent composition comprising compounds that collectively provide a beef scent, and the beef flavor scent composition is present in an amount ranging from three (3) to eight (8) percent by weight of the beef flavor scent emulsion. The beef flavor scent emulsion further comprises MCT in an amount ranging from 60-65 percent by weight of the beef flavor scent emulsion and sunflower oil in an amount ranging from 28-33 percent by weight of the beef flavor scent emulsion.

The flavor scent emulsion for peanut butter comprises a peanut butter flavor scent composition comprising compounds that collectively provide a peanut butter scent, and the peanut butter flavor scent composition is present in an amount ranging from 25-30 percent by weight of the peanut butter flavor scent emulsion. MCT is present in an amount ranging from 69 to 74 percent by weight of the peanut butter flavor scent emulsion. No separate emulsifier is used.

The flavor scent emulsion for chicken comprises a chicken flavor scent composition comprising compounds that collectively provide a chicken scent and the chicken flavor scent composition is present in an amount ranging from five (5) to ten (10) percent by weight of the chicken flavor scent emulsion. MCT is present in an amount ranging from 89-94 percent by weight of the chicken flavor scent emulsion. No separate emulsifier is used.

After cooling, the flattened and scent-infused sheets of RSS-3 rubber are cut into strips that are fed to an injection molding machine having a mold that defines the shapes of the sleeves. The process variables (e.g., molding time and temperature) are the same for all tested sleeves. The injection molding is carried out at an injection molding temperature of from about 145° C. to about 155° C. for an injection molding period of from about 7 minutes to about 8 minutes. The sleeve dimensions for all sleeves are substantially the same.

### Phase I—Determining if the Dog Has Scented Sleeve Preference

For each dog, four substantially identical bowls are fitted with the foregoing elastic sleeves, three of the sleeves have one of a beef, chicken, or peanut butter flavor scent incorporated in them, and one of the sleeves is unscented. As explained above, the sleeves are formed using the same process and ingredients, except that they differ in terms of the particular flavor scent emulsion that is used and in the case of the unscented sleeve, no flavor scent emulsion is used. For the scented sleeves, the flavor scent emulsion is added in the same amount by weight of the sleeve.

The sleeved bowls are lined up in a room and are easily accessible for the dogs. The bowls are filled with water up to the brink of the water bowl. All bowls are therefore always simultaneously available. Before placing the bowls, all the dogs' existing water bowls are removed for the study duration. The owners are instructed to refill the bowls even if a single bowl is half empty. The test is conducted for four consecutive days. Every 24 hours, all of the bowls are refilled if any of the bowls is half empty, and the positions of the bowls are randomly rearranged every day to account for ordering effects regarding the location of the bowls.

To record the water consumption of dogs, custom digital food weighing scales are designed and built. Each scale is controlled by an Adafruit Feather 32u4 Bluefruit and Adafruit Feather 32u4 Adalogger along with a load cell amplifier. The Adafruit Feather 32u4 Adalogger acts as a data logger with a built-in micro-SD card socket for data storage and battery-backed real time clock (FIG. 2). The SparkFun Load Cell Amplifier-HX711 is connected to the load cell of a VK-2D Kitchen Scale Series. The apparatus is powered by an external lithium ion 4400 mAh battery. The scale us programmed to record timestamped weights within 1 g accuracy every 5 s.

Prior to acquiring weight measurements, each scale is calibrated. A precision 2,000 g calibration weight is added and removed from the scale. The regression coefficients for the scale are then calculated, and accuracy is confirmed to be within 1 g accuracy using multiple smaller weights. Weight samples are measured to record continuous water consumption every five seconds for 24 hours for the four different water bowl sleeves (beef, peanut butter, chicken, and non-scented). Each water bowl is placed on a scale. To identify water consumption events, the raw weight CSV data file is processed with a custom-built algorithm for R. The algorithm first calculates a 5-point moving average of the weights from the raw data file. Raw weight values that deviate from the calculated moving average by more than 5 grams are filtered out. These deviant values are indicative of unstable weight readings and are filtered out to attain reliable weight data representations. The filtered data set of stable weights is passed to a function to calculate serial losses of weight (i.e. water).

An event of water consumption is only considered when there is a weight loss of more than two grams within subsequent time points. All weight losses greater than 2 g is retained to indicate water consumption events. To validate the algorithm, it is applied to 12 data files (~288 hours of data collection) to measure the water consumption events and manually calculate all weight losses based on visual inspection of the raw data. The values obtained from the visual inspection of the raw data files and the algorithm approach are then compared according to the timestamp. Based on this assessment a miscalculation of five out of 95 identified water consumption events is detected.

These miscalculations from the raw data are believed to be due to the transient fluctuations in the weight for reasons other than drinking (e.g., a dog nudging the scale or putting some pressure on the scale). The fluctuations are identified when the weight first increases to a value and then returns to its original stable weight value. The fluctuations that occur within 10 seconds of the time frame are then returned to their original value of the stable weight after 10 seconds and are considered transient fluctuations. In total, across the 288 hours of data collection, 22.24 g of water are determined to be miscalculated by the algorithm out of a total 3941.44 g of water consumption calculated. This reflects an overall, 0.56% error rate, which is determined sufficient to evaluate 24 hr. water consumption from each bowl. Thus, the algorithm provides an accurate calculation of the weight of consumed water with an error rate of 0.56% compared to manually calculating water consumption from the weight data.

The raw data is processed by the algorithm to identify all water consumption events. The daily water consumption is calculated for each dog for sleeves with each scent and an unscented sleeve. The consumption is then divided by the dog's body mass to calculate water consumption per kg of body mass (ml/kg). A linear mixed effect model is used to compare daily water consumption predicted by scent with a random intercept of individual. All statistical tests are conducted in R Studio (R Core Team, 2023).

In Phase 1, based on the water consumption of twenty (20) dogs across the four bowls for 4 days (1,920 hours in total), the dogs show a non-statistically significant higher water consumption from bowls with scented sleeves compared to non-scented. This increase ranges from 0.5 ml/kg for peanut butter vs. non-scented to 2.96 ml/kg greater consumption for chicken versus non-scented. Inspection of individual data highlights individual-level differences in preference. From the original sample, 10 dogs exhibiting this individual-level preference for either chicken or beef scented sleeves are tested in Phase II.

### Phase II—Water Consumption For Dogs Preferring Scented to Unscented Sleeves

Out of 20 dogs from Experiment 1, 10 dogs are selected based on their observed individual preference between a chicken or beef scented sleeve and a non-scented sleeve. Preference is indicated by a larger quantity of water consumed with one of the scented sleeves in Experiment 1. Out of ten (10) dogs, six (6) dogs prefer beef and four (4) prefer chicken.

Out of ten (10) dogs, three (3) are from multi-dog households. However, they are included with the proviso that the dogs do not share their water bowls. Each dog is provided with two water bowls, one having an unscented sleeve, and one having a sleeve with an emulsified flavor scent composition for the flavor that the dog is determined to prefer in Phase I. The two bowls are simultaneously available within 0.5 meters apart within a room that is accessible to the dogs. The bowls are filled with water up to the brink of the water bowl. The same scales from Phase I are used to record the water consumption. Continuous recordings of water consumption are collected over an increased 14-day period (“increased” meaning as compared to the four (4) day period in Phase I). The dogs' existing water bowls are removed for the study duration, the bowls are refilled continuously as needed. Also, the locations of the bowls are swapped daily to account for potential side bias. Due to the increased duration of testing, the algorithm used in Phase I is refined to collect water consumption every 30 seconds instead of every 5 seconds. To account for variables that may assist in explaining water consumption, consenting owners are asked to report on the type of food they provide their dog (Dry: dry only, or Wet: wet only and combination of wet and dry) as well the level of physical activity their dog receives (<30 min, 30 min-1 hr, or >1 hr).

Similar to Phase I, the raw data water consumption data is processed to calculate water consumption per kg of body mass (ml/kg). To get the daily water consumption for each dog, the total water consumption for each dog is divided by 14. The time between 6 am to <12 pm is referred as morning, 12 pm to <6 pm is considered as afternoon. 6 pm to <12 am is considered as evening and 12 am to <6 am is considered as night. Two linear mixed-effect models are created to explore the influence of sleeve type (preferred scented vs non-scented), food type (dry vs wet), age, and daily physical activity on daily water consumption, with dog included as a random effect. Additionally, two linear mixed models are created to understand whether the number of water consumption events and water quantity consumed per event are predicted by sleeve type (preferred scent vs non-scented), with dog included as a random effect. All statistical tests are conducted in R Studio (R Core Team, 2023). The models are fitted using the lme4 package (Bates et al., 2015). Error bar plots were created using the ggplot2 package (v3.4.2; Wickham, 2016).

In Phase II dogs show an increased consumption of 5.26 ml water)/kg body weight with their preferred scented sleeve compared to non-scented sleeves over a 14-day period. Furthermore, food type is found to influence water intake as dogs fed a dry diet consume more water per day compared to those with wet food integrated in their diet. This finding aligns with previous research that suggests dogs housed in controlled laboratory conditions following a water deprivation consume 24 ml/kg of water when fed wet food and 60 ml/kg when fed dry food (Ramsay & Thrasher, 1991). When observing the drinking pattern of dogs, consumption is higher during the evening, with the second highest occurring in the afternoon and the least occurring overnight. This drinking pattern could be influenced by the increased physical activity that likely occurs in the evening when most owners are home and available to facilitate their activity (e.g., walks, active play).

Based on the data related to water consumption events, there is an observed significant increase in the number of water consumption events for the scented sleeves suggesting that dogs are more likely to approach the preferred scented sleeve than a non-scented sleeve. Dogs, however, do not increase consumption per water bowl visit for the scented vs. non-scented sleeve. This suggests that dogs prefer to drink from the preferred scented bowl, but do not consume more while there. Also, age and daily physical activity do not appear to influence water consumption.

The foregoing descriptions of specific embodiments have been presented for purposes of illustration and description. They are not intended to be exhaustive or to limit the invention to the precise forms disclosed. Many modifications and variations are possible in light of the above teachings, with modifications and variations suited to the particular use contemplated.

1. An apparatus configured to removably enclose a portion of an animal water bowl, the apparatus comprising:
an elastomeric sleeve comprising a flavor scent composition incorporated within the elastomeric sleeve, wherein the flavor scent composition has a scent that is emitted from the elastomeric sleeve.

2. The apparatus of claim 1, wherein the flavor scent composition is a liquid flavor scent composition.

3. The apparatus of claim 1, wherein the flavor scent composition is emulsified.

4. The apparatus of claim 1, wherein the elastomeric sleeve comprises natural rubber.

5. The apparatus of claim 1, wherein the elastomeric sleeve is a molded elastomeric sleeve.

6. The apparatus of claim 1, wherein the elastomer sleeve comprises a polymeric matrix, and the flavor scent composition is incorporated within the polymeric matrix.

7. The apparatus of claim 1, wherein the flavor scent composition comprises an emulsifier.

8. The apparatus of claim 1, wherein the elastomeric sleeve comprises a cylindrical side wall having a height axis and a radial axis, a top opening, and a radially-inward projecting flange defining a bottom opening.

9. The apparatus of claim 1, wherein the flavor scent composition is a food flavor scent composition, and the scent corresponds to the food flavor.

10-20. (canceled)

21. An animal hydration-enhancing water bowl, comprising:
the elastomeric sleeve of claim 1; and
a bowl having an open interior volume and a height defining a height axis, wherein the elastomeric sleeve is removably placed around the bowl so that the elastomeric sleeve encircles the bowl along at least a portion of the bowl's height.

22. The animal hydration-enhancing water bowl of claim 21, wherein the elastomeric sleeve comprises natural rubber.

23. The animal hydration-enhancing water bowl of claim 21, wherein the flavor scent composition is a liquid flavor scent composition.

24. The animal hydration-enhancing water bowl of claim 21, wherein the flavor scent composition comprises an emulsifier.

25. The animal hydration-enhancing water bowl of claim 21, wherein the elastomeric sleeve comprises natural rubber.

26. The animal hydration-enhancing water bowl of claim 21, wherein the elastomeric sleeve is a molded elastomeric sleeve.

27. The animal hydration-enhancing water bowl of claim 21, wherein the elastomeric sleeve comprises a cylindrical side wall having a height axis and a radial axis, a top opening, and a radially-inward projecting flange defining a bottom opening.

28. The animal hydration-enhancing water bowl of claim 21, wherein the flavor scent composition is a food flavor scent composition, and the scent corresponds to the food flavor.

29. The animal hydration-enhancing water bowl of claim 21, wherein the elastomeric sleeve comprises natural rubber and a cylindrical side wall having a height axis and a radial axis, a top opening, and a radially-inward projecting flange defining a bottom opening, and the flavor scent composition is an emulsified, liquid, food flavor scent composition with a scent corresponding to the food flavor.
